(19) United States
(12) Patent Application Publication
(10) Pub. No.: US 2024/0043959 A1
(43) Pub. Date: Feb. 8, 2024

(54) DIRECTED LASER ENERGY TO REDUCE METAL OXIDES

(71) Applicant: Limelight Steel Inc., Oakland, CA (US)

(72) Inventors: Olivia Faye DIPPO, Oakland, CA (US); Andrew Zigang ZHAO, Oakland, CA (US)

(21) Appl. No.: 18/548,538

(22) PCT Filed: Mar. 3, 2022
(86) PCT No.: PCT/US2022/018766

§ 371 Date: Aug. 31, 2023

Related U.S. Application Data
(60) Provisional application No. 63/156,283, filed on Mar. 3, 2021.

(51) Int. Cl. C22B 5/10; C22B 5/12; B22F 9/08

(52) U.S. Cl. CPC C22B 5/10; C22B 5/12; B22F 9/08

(57) ABSTRACT

A system and method for producing an intermediate metal product without generating significant carbon dioxide emissions is described herein. A metal oxide heated by at least one laser, combined with a heated reducing agent, produce an intermediate metal product. Further processing may produce a metal, which may optionally be combined with at least one alloying element to produce a metal alloy and may have impurities removed. A resultant metal powder from even further processing may be produced.

### CROSS-REFERENCE TO RELATED APPLICATIONS

This application claims priority from U.S. Provisional Application No. 63/156,283, filed on Mar. 3, 2021, which is incorporated herein by reference in its entirety.

### FIELD

The present teachings relate to a system and methods for reducing an oxidized metal, producing a non-oxidized metal, or producing a non-oxidized metal alloy.

### INTRODUCTION

The current production of metals emits significant amounts of greenhouse gases, and it is paramount to reduce these emissions to combat climate change. Currently, burning coal or natural gas is used to generate the heat and carbon monoxide for reducing metal oxides into metal, which may emit immense amounts of carbon dioxide in the process. Even after this process, further energy and carbon intensive processes may be required to convert to the desired metal alloy composition and to form a final shape.

Blast furnaces are a conventional processing method to convert metal oxides like iron oxide into metals like iron or steel. Iron oxide ore and coke (from coal) are continuously added to a furnace that melts the materials and chemically converts the metal oxide into metal. Blast furnaces can generate 1,000 kg of crude steel using roughly 1,370 kg of iron oxide ore and 780 kg of coal. Prior art in blast furnaces include a “Blast furnace to convert iron oxide into pig iron” from Standard Oil (US46244A) or a “Method of treating iron ore blast furnaces” (U.S. Pat. No. 2,715,575A) from Barium Steel Corp. Both detail ways of introducing oxygen and water vapor into the furnace containing iron oxide and coke to provide sufficient combustible materials for heat and reducing agents for the chemical reduction of iron oxide.

Direct Reduced Iron is created by the reduction of solid iron ore pellets using carbon monoxide from burning coal or natural gas. Iron oxide pellets are not smelted as they are in blast furnaces; instead, they remain in the solid state at temperatures below the melting point during the chemical conversion into iron. Thus, generating direct reduced iron is more energy efficient than reducing iron-oxide into iron using a blast furnace. Direct reduced iron can be used in electric arc furnaces or basic oxygen furnaces to convert the carbon-rich pig iron into the desired steel alloy.

A potential carbon free reducing agent for turning metal oxide into a metal, such as iron oxide into iron, is hydrogen. A benefit of hydrogen is that water would be the byproduct of the reaction between hydrogen and a metal oxide like iron oxide, not carbon dioxide. There has been research done on a technique called “flash ironmaking,” which flows iron oxide particles through a 1200-1600° C. furnace containing hydrogen, converting them into 99% iron in about 3 seconds, as described in US patent application No. US20200048724A1 and PCT patent application no. PCT/CN2015/095560. However, such furnaces would only create iron powder and feedstock for future processing, rather than a finished metal product, which takes more energy and can emit even more carbon dioxide if the energy source is burning fossil fuels.

To improve the energy and material efficiency of manufacturing, an alternate manufacturing technique is additive manufacturing (i.e., 3D printing). A relevant method is directed-energy deposition, as described in U.S. Pat. No. 5,837,960A. Directed-energy deposition uses powder particles blown into the stream of a heat source such as a laser or an electron beam to melt the particles into the desired geometry, building layer-upon-layer.

There also exist methods within the field of 3D printing for reactive printing, in which the starting materials (reactants) are converted into different materials (products) before, during, or after the printing process takes place. The reactants can be metal precursor pastes mixed with binders and solvents, which are reduced to a metal product after the printing process, as described US Patent Application No. US20150035209A1. Related is PCT application no. PCT/US2016/068490, which employs an energy beam to selectively fuse a material to produce an object, along with using a reactive fluid to manipulate the surface chemistry and composition prior to, during, or after the application of an energy beam.

U.S. Pat. No. 5,182,170A discloses the use of selective laser sintering and reactive gases in an additive manufacturing process, which first deposits layers of powder, then reacts them with a gas environment and a laser heat source. U.S. patent Ser. No. 10/507,638B2 discloses combining reactants in powder, paste, liquid, or gas form and using laser energy to deposit a reaction product layer by layer.

A versatile system that is able to heat metal oxides and produce metals and metal alloys, all while reducing carbon dioxide emissions and energy requirements, would be of great benefit.

### SUMMARY

A system is provided for producing an intermediate metal product without generating significant carbon dioxide emissions. The system is comprised of a reducing agent in communication with a metal oxide, and a laser furnace in which the reducing agent and the metal oxide come in contact. The laser furnace is comprised of at least one laser that interacts with the metal oxide. Lasers may have various wavelengths, ranging from about 180 nm to about 10,600 nm, and the laser may be a continuous wave laser or a pulsed laser. The laser power may range from about 1 Watt to about 1 gigawatts, with the laser power being tunable depending on the metal oxide's particle size and the desired reaction time; more power leads to a faster rise in temperature and reduction reaction. In some embodiments, there is one laser whose wavelength may range from about 180 nm to about 600 nm. In other embodiments, there are more than one laser, with each laser ranging from about 180 nm to about 600 nm. In yet other embodiments, there are more than one laser with the same wavelength. In yet other embodiments, there are more than one laser with combinations of the same wavelength and differing wavelengths. The laser associated with the laser furnace may be chosen based on the light absorption range of the metal oxide to be reduced. The wavelengths of the lasers may also be altered through higher harmonic generation. The intermediate metal product that is produced as a result of combining the reducing agent and the metal oxide has a metallization ranging from about 50% to about 99% (i.e., being between about 50% and about 99% metal). In other embodiments, the power of the laser ranges from about 1 Watt to about 100 megawatts. In other embodiments, the power of the laser ranges from about 1 Watt to about 10 megawatts. In other embodiments, the power of the laser ranges from about 1 Watt to about 1 megawatt. In other embodiments, the power of the laser ranges from about 1 Watt to about 100 kilowatts. In other embodiments, the power of the laser ranges from about 1 Watt to about 10 kilowatts. In other embodiments, the power of the laser ranges from about 1 Watt to about 1 kilowatt. In other embodiments, the power of the laser ranges from about 1 Watt to about 100 Watts. In other embodiments, the power of the laser ranges from about 1 Watt to about 10 Watts.

The reducing agent may be one of a number of agents, such as hydrogen, carbon (as coke, coal, or carbon black), and carbon monoxide. Generation of carbon dioxide from the reaction of the reducing agent and the metal oxide is dependent on the reducing agent that is used.

The reducing agent and the metal oxide are heated separately before combining to produce the intermediate metal product. In an embodiment, the reducing agent and the metal oxide are heated to the same temperature. In another embodiment, the reducing agent and the metal oxide are heated to differing temperatures. In an embodiment, the reducing agent is heated to its temperature before coming in contact with the metal oxide in the laser furnace. In this embodiment, the metal oxide is heated in the laser furnace to its temperature and then is contacted with the reducing agent at its temperature.

The wavelength of the laser that interacts with the metal oxide may take on a number of ranges. In various embodiments, the laser wavelength may range from about 180 nm to about 10,600 nm. In other embodiments, the laser wavelength may range from about 300 nm to about 10,000 nm. In even other embodiments, the laser wavelength may range from about 400 nm to about 9,000 nm. In even other embodiments, the laser wavelength may range from about 500 nm to about 8,000 nm. In even other embodiments, the laser wavelength may range from about 600 to about 7,000 nm. In even other embodiments, the laser wavelength may range from about 700 nm to about 6000 nm. In even other embodiments, the laser wavelength may range from about 800 nm to about 5000 nm. In even other embodiments, the laser wavelength may range from about 900 nm to about 4000 nm. In even other embodiments, the wavelength may range from about 1000 nm to about 3000 nm. In even other embodiments, the wavelength may range from about 425 nm to about 475 nm. In even other embodiments, the wavelength may range from about 300 nm to about 700 nm. The laser wavelength is dependent on the light absorption range of the metal oxide being reduced.

In an embodiment, the laser furnace may be a steel quadrangular shaft or a steel circular shaft, lined with a refractory ceramic coating on its inner surface. The refractory ceramic coating may be a number of materials. In an embodiment, the refractory ceramic coating may be aluminum oxide. In an embodiment, the refractory ceramic coating may be zirconium oxide. In an embodiment, the refractory ceramic coating may be silicon carbide. In an embodiment, the refractory ceramic coating may be graphite. In an embodiment, the refractory ceramic coating may be silicon oxide. In an embodiment, the refractory ceramic coating may be combinations of aluminum oxide, zirconium oxide, silicon carbide, graphite, and silicon oxide.

Impurities may be removed from the intermediate metal product, the metal, or the metal alloy. Fluxes may be used to react with the impurities to remove them from the intermediate metal product, the metal, or the metal alloy. In an embodiment, impurities are not removed from the intermediate metal product. In an embodiment, impurities are not removed from the metal. In an embodiment, impurities are not removed from the metal alloy.

The intermediate metal product may be combined with at least one alloying element. The metal may be combined with at least one alloying element.

The present invention may comprise a heating system, with the heating system being used to heat the reducing agent to a temperature at which it reacts with the metal oxide. The heating system may be comprised of a number of components, including induction heaters, resistive heaters, electron beams, microwaves, heat pumps, heat exchangers, plasma heaters, and combinations thereof. The heating system heats the reducing agent to a temperature ranging from about 500° C. to about 1500° C.

The heating system for heating the reducing agent may comprise induction heaters, resistive heaters, electron beams, microwaves, heat pumps, heat exchangers, plasma heaters, and combinations thereof. One of skill in the art would recognize that there are even other systems that can heat the reducing agent.

The metal oxide, when reacting with the reducing agent, is heated by at least one laser to a temperature between about 500° C. and about 2500° C.

At least one laser interacts with the metal oxide for a time ranging from about 0.00001 seconds to about 1 hour to heat it to the temperature range at which it reacts with the reducing agent. In another embodiment, at least one laser interacts with the metal for a time ranging from about 0.0001 seconds to about 30 minutes. In another embodiment, at least one laser interacts with the metal oxide for a time ranging from about 0.001 seconds to about 15 minutes. In another embodiment, at least one laser interacts with the metal oxide for a time ranging from about 0.01 seconds to about 5 minutes. In another embodiment, at least one laser interacts with the metal oxide for a time ranging from about 0.1 seconds to about 1 minute.

The present invention also includes a method for producing an intermediate metal product without generating significant carbon dioxide. A step is to provide a system for producing an intermediate metal product. The system is comprised of a reducing agent in communication with a metal oxide, and a laser furnace in which the reducing agent and the metal oxide come in contact. The laser furnace is comprised is of at least one laser that interacts with the metal oxide. Lasers may have various wavelengths, ranging from about 180 nm to about 10,600 nm, and the laser may be a continuous wave laser or a pulsed laser. The laser power may range from about 1 watt to about 1 gigawatt, with the laser power being tunable depending on the metal oxide's particle size and the desired reaction time; more power leads to a faster rise in temperature and reduction reaction. Another step is producing an intermediate metal product, which is the result of combining the reducing agent and the metal oxide within the laser furnace. The intermediate metal product has a metallization ranging between about 50% and about 99%.

At least one alloying element may be added to the intermediate metal product. In another embodiment, no alloying element is added to the intermediate metal product.

The metal oxide, within the laser furnace, is heated to a temperature between about 500° C. and about 2500° C. At least one laser interacts with the metal oxide to bring the metal oxide to this temperature range.

A heating system heats the reducing agent to a temperature range from between about 500° C. and about 1500° C., after which the reducing agent interacts with the metal oxide, which has been heated in the laser furnace. The heating system may comprise of at least one of induction heaters, resistive heaters, electron beams, microwaves, heat pumps, heat exchangers, plasma heaters, and combinations thereof.

To heat the metal oxide to its temperature range, at least one laser interacts with the metal oxide for a time ranging from about 0.00001 seconds to about 1 minute. Once the metal oxide is at its temperature range, it may come in contact with the reducing agent that has been heated to its temperature range.

During the intermediate metal product production process, impurities may be removed from the intermediate metal product via fluxes that react with the impurities. In another embodiment, no impurities are removed from the intermediate metal product.

At least one alloying element may be added to the intermediate metal product. In another embodiment, no alloying elements are added to the intermediate metal product.

In an embodiment, the intermediate metal product may be fed to an atomizer to produce a metal powder. In another embodiment, a metal may be fed to an atomizer to produce a metal powder. In another embodiment, a metal alloy may be fed to an atomizer to produce a metal powder. The powder may take on a number of particles shapes and particle sizes, depending on required specifications.

The metal oxide may be fed to at least one of an electric arc furnace, a blast furnace, a shaft furnace, a fluidized bed reactor, a basic oxygen furnace, and a molten oxide electrolysis chamber for further processing. In an embodiment, further processing yields an intermediate metal product. In another embodiment, further processing yields a metal. In another embodiment, further processing yields a metal alloy.

The laser furnace may take a number of configurations, such as a falling particle design, shaft furnace, rotary kiln, and a fluidized bed. At least one laser interacts with the metal oxide to heat it to a temperature, and a separate heating system interacts with the reducing agent. The temperature at which a laser interacts with the metal oxide may range from about 500° C. to about 2500° C. The temperature at which a heating system interacts with the reducing agent is from about 500° C. to 1500° C. The time in which the laser interacts with metal oxide may range from about 0.00001 seconds to about 1 minute.

The reaction between the metal oxide and the reducing agent produces an intermediate metal product, comprising 50-99% metal, with some residual metal oxide and impurities. The time in which the reducing agent is in contact with the metal oxide to promote a reduction reaction may range from 0.01 seconds to 10 hours.

In some embodiments, the intermediate metal product enters a vessel, wherein the intermediate metal product is molten. Flux is added to react with impurities in the intermediate product, and remove those impurities, to form metal.

In some embodiments, the metal combines with at least one alloying element to produce a metal alloy. In other embodiments, there is no alloying element and solely the metal is produced.

In embodiments in which there is no alloying element, the metal may be fed through an atomizer to produce a metal powder. In embodiments in which there is at least one alloying element, the metal alloy may be fed through an atomizer to produce a metal alloy powder.

In embodiments in which there is no alloying element, a metal powder may be deposited onto a base material. In embodiments in which there is at least one alloying element, the metal powder may be deposited onto a base material. In either instance, a laser is interacting with the metal powder to deposit the powder onto the base material, with the wavelength of the at least one laser ranging from about 180 nm to about 10,600 nm.

The base material that receives either the metal or the metal alloy may be positioned on a stage that may be temperature-controlled. In another embodiment, the stage is not temperature-controlled. The stage is capable of moving linearly and rotationally, which allows either the metal or metal alloy to be deposited on different areas of the base material.

In some embodiments, a series of optics may be used to focus the at least one laser during the deposition of either the metal or the metal alloy.

In addition to at least one laser, a heating system may be included in the system so that the heating of the reducing agent, the production of the intermediate metal product, and production of either the metal or the metal alloy may occur. The heating system may utilize other heating elements, such as induction heaters, resistive heaters, electron beams, microwaves, heat pumps, heat exchangers, plasma heaters, and a combination thereof.

To be deposited onto the base material, the laser and either the metal or the metal alloy arrive at a particular area of the base material concurrently. Either the metal or the metal alloy is deposited onto the base material in a sequential fashion, with the laser scanning the base material as either metal or metal alloy is arriving at that particular area on the base material.

### DRAWINGS

Those of skill in the art will understand that the drawings, described below, are for illustrative purposes only. The drawings are not intended to limit the scope of the present teachings in any way.

FIG. 1. A depiction of the laser furnace and the metal oxide.

FIG. 2. A depiction of the system including a heating system for the reducing agent and an intermediate metal product.

FIG. 3. A depiction of the system in series with a vessel to remove impurities from the intermediate metal product.

FIG. 4. A depiction of the system in in series with a vessel to remove impurities from and add alloying element(s) to the metal.

FIG. 5. A depiction of the system in series with an atomizer to make the metal in powder form.

FIG. 6. A depiction of the system in series with a metal 3D printer made up of a laser heater and temperature-controlled stage to deposit a metal.

FIG. 7. A depiction of the system in series with a metal 3D printer made up of a laser heater, temperature controlled stage, and feed to combine the metal powder with alloying element(s) to deposit an alloy.

FIG. 8. A depiction of the system including the laser furnace to heat the metal oxide in series with a vessel to remove impurities and create a metal product.

FIGS. 9A-B. Graphs that show Temperature (A) and Energy (B) associated with various hydrogen reduction routes in comparison to a blast furnace.

FIG. 10. A method of using the system to create an intermediate metal product, metal or metal alloy.

FIG. 11. A method of using the system to create metal powder.

FIG. 12. A method of using the system to deposit metal or metal alloy onto a base material.

### DETAILED DESCRIPTION

### Abbreviations and Definitions

To facilitate understanding of the invention, a number of terms and abbreviations as used herein are defined below as follows:

Metal: As used herein, the term metal refers to a material that is the product of a reaction between a metal oxide and a reducing agent. Examples of metals include Beryllium, Sodium, Magnesium, Aluminum, Silicon, Potassium, Calcium, Scandium, Titanium, Vanadium, Chromium, Manganese, Iron, Cobalt, Nickel, Copper, Zinc, Gallium, Germanium, Arsenic, Rubidium, Strontium, Yttrium, Zirconium, Niobium, Molybdenum, Technetium, Ruthenium, Rhodium, Palladium, Silver, Cadmium, Indium, Tin, Antimony, Cesium, Barium, Hafnium, Tantalum, Tungsten, Rhenium, Osmium, Iridium, Platinum, Gold, Mercury, Thallium, Lead, Bismuth, and Polonium.

Metal oxide: As used herein, the term metal oxide refers to a material that, when reacted with a reducing agent, produces a metal. One of skill in the art would recognize that the metal oxide may include impurities, including but not limited to one or additional metals, as well as the same metal having more than one oxidation state. Examples of metal oxides include Iron(II) oxide—wüstite (FeO) or magnetite (Fe3O4), iron(III) oxide—alpha phase hematite (α—Fe2O3), beta phase, (β-Fe2O3), gamma phase maghemite (γ—Fe2O3), epsilon phase, (ε—Fe2O3), Beryllium Oxide, Sodium Oxide, Magnesium Oxide, Aluminum Oxide, Silicon Oxide, Potassium Oxide, Calcium Oxide, Scandium Oxide, Titanium Oxide, Vanadium Oxide, Chromium Oxide, Manganese Oxide, Cobalt Oxide, Nickel Oxide, Copper Oxide, Zinc Oxide, Gallium Oxide, Germanium Oxide, Arsenic Oxide, Rubidium Oxide, Strontium Oxide, Yttrium Oxide, Zirconium Oxide, Niobium Oxide, Molybdenum Oxide, Technetium Oxide, Ruthenium Oxide, Rhodium Oxide, Palladium Oxide, Silver Oxide, Cadmium Oxide, Indium Oxide, Tin Oxide, Antimony Oxide, Cesium Oxide, Barium Oxide, Hafnium Oxide, Tantalum Oxide, Tungsten Oxide, Rhenium Oxide, Osmium Oxide, Iridium Oxide, Platinum Oxide, Gold Oxide, Mercury Oxide, Thallium Oxide, Lead Oxide, Bismuth Oxide, and Polonium Oxide.

Intermediate metal product: As used herein, the term intermediate metal product refers to a material that is partially or mostly converted from metal oxide to metal, but still contains some metal oxide. The degree of metallization ranges from about 50% to about 99%.

Flux: As used herein, the term flux refers to a material that is added to the intermediate metal product to react with impurities, so that those impurities may be extracted from the intermediate metal product. Examples of flux include Limestone, Calcium Oxide, Calcium Hydroxide, Calcium Carbonate, Calcium Fluoride, Magnesium Oxide, Magnesium Carbonate, Calcium Magnesium Carbonate, Calcium Fluoride, Silicon Oxide, Sodium Borate, Manganese Oxide, Lithium Chloride, Sodium Chloride, Potassium Chloride, Magnesium Chloride, Ammonium Chloride, Zinc Chloride, Sodium Hexafluoroaluminate, Barium Chloride, and combinations thereof.

Metal alloy: As used herein, the term metal alloy refers to a material that at least has a metal as a component. One of skill in the art would recognize that the metal alloy may include impurities, including but not limited to one or additional metals, as well as the same metal having more than one oxidation state. Examples of metal alloys include Stainless steel such as 316 or 316L, austenitic steel such as 304 or 304L, ferritic steel such as 430 or 434, martensitic steel such as 44, High carbon steel such as 1080, Low carbon/mild steel such as A36, Medium carbon/high-tensile steel such as 4140, 4340, Alloy steel such as 6150, 8620, Titanium alloys such as Ti-6Al-4V, and Nickel alloys such as 625, 718.

Alloying element: As used herein, the term alloying element refers any element that can be added to the intermediate metal product. Examples of alloying elements include Aluminum, Bismuth, Boron, Carbon, Chromium, Cobalt, Copper, Lead, Manganese, Molybdenum, Nickel, Niobium, Phosphorus, Silicon, Sulfur, Tantalum, Titanium, Vanadium, and combinations thereof.

Laser furnace: As used herein, the term laser furnace refers to any physical configuration in which at least one laser may interact with matter within the chamber.

Reducing agent: As used herein, the term reducing agent refers to a material that reacts with a metal oxide to produce a metal. Examples of reducing agents are hydrogen, carbon (in the form of coal, coke, or carbon black), and carbon monoxide.

Impurity: As used herein, the term impurity refers to any element or compound that is not the desired metal or metal alloy. Examples of impurities include sulfur, phosphorus, silicon, oxygen, carbon, and manganese.

Laser: As used herein, the term laser refers to a device that emits light through a process of optical amplification based on the stimulated emission of electromagnetic radiation. Examples of lasers include CO2 lasers (9,200-11,400 nm), Xe—He lasers (2000-4000 nm), He—Ne lasers (˜533-633 nm, 1152-3391 nm), Er:YAG lasers (2900-2940 nm), Dye lasers (˜380-1000 nm), InGaAs lasers (904-1065 nm), AlGaIn/AsSb lasers (1870-2200 nm), Ti:Sapphire lasers (650-1130 nm), Ruby lasers (694 nm), Cr Fluoride lasers (780-850 nm), Alexandrite lasers (700-800 nm), GaAlAs lasers (750-850 nm), InGaAlP lasers (630-685 nm), GaN lasers (515-520 nm), Copper vapor lasers (510.5 nm), Ar lasers (488-515 nm), InGaN lasers (370-493 nm), Nd:YAG lasers (946-1319 nm), Nd: Glass lasers (1,054 to 1,062 nm), Nitrogen lasers (337 nm), Fiber lasers (˜500-2100 nm), and combinations thereof.

Directed Laser Energy to Reduce Metal Oxides

Unlike other systems that emit significant amounts of CO₂ and require inordinate amounts of energy to reduce metal oxides to metals, the present invention reduces carbon emissions and energy consumption to produce the same metal. In an embodiment that uses laser energy, the present invention can produce up to 12,000 tons of molten metal per day, replacing a blast furnace, current technology that generates carbon emissions. Others may produce metals from metal oxides without producing carbon emissions, but they do so at lower temperatures than the present invention, which slows down the metal oxide reduction reaction, and constricts output. Others may produce metals from metal oxides without using laser heat, which results in significantly lower energy efficiency and greater overall energy input. These other methods may reduce carbon dioxide emissions, but they can not melt the metal oxide or produce molten metal, requiring further processing to remove impurities and produce a metal product. Laser energy provides a novel industrial heat source to reduce metal oxides into metals, while also reducing CO₂ emissions.

Using hydrogen as the reducing agent may cause issues, as excessive amounts of hydrogen have been known to embrittle resulting metals that are produced. The present invention limits the exposure time of the hydrogen to the metal oxide to at most about 10 hours to minimize embrittlement.

Hydrogen as the reducing agent may be combined with other fluids, such as nitrogen, argon, oxygen, water, compressed air, and dry air. These fluids may be used to limit the concentration of hydrogen to minimize embrittlement. These fluids may be used to regulate the reduction reaction kinetics and thermodynamics, in addition to being used as a carrier or purge fluid. In various embodiments, these fluids may be housed in an inert gas chamber for eventual mixing with the reducing agent. In other embodiments, these fluids may be housed in the same chamber as the reducing agent.

Various lasers may be used to target the wavelengths that are in the absorption band of the metal-oxide, such as CO₂ lasers, dye lasers, indium gallium nitride lasers, neodymium doped yttria aluminum garnet lasers, neodymium doped glass lasers, and titanium doped sapphire lasers. One of skill in the art would recognize that many lasers may be used to heat the metal oxide as long as the desirable wavelengths are available. In various embodiments, the laser wavelength may range from about 180 nm to about 10,600 nm. In other embodiments, the laser wavelength may range from about 300 nm to about 10,000 nm. In even other embodiments, the laser wavelength may range from about 400 nm to about 9,000 nm. In even other embodiments, the laser wavelength may range from about 500 nm to about 8,000 nm. In even other embodiments, the laser wavelength may range from about 600 to about 7,000 nm. In even other embodiments, the laser wavelength may range from about 700 nm to about 6000 nm. In even other embodiments, the laser wavelength may range from about 800 nm to about 5000 nm. In even other embodiments, the laser wavelength may range from about 900 nm to about 4000 nm. In even other embodiments, the wavelength may range from about 1000 nm to about 3000 nm. In even other embodiments, the wavelength may range from about 425 nm to about 475 nm. In even other embodiments, the wavelength may range from about 300 nm to about 700 nm.

In various embodiments, the laser arrangement may vary. There may be one laser which may be focused onto a point, defocused, or split into many beams using a system of optics comprising mirrors and lenses. In other embodiments, there may be an array of lasers, arranged in a flat or curved panel.

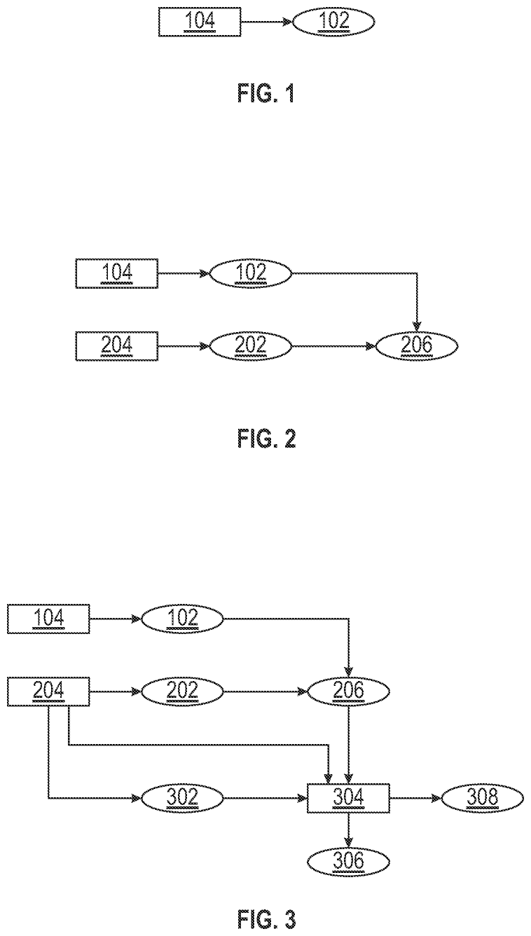

FIG. 1 depicts a metal oxide 102 heated to a target temperature by a laser furnace 104. The target temperature for the metal oxide may be between about 500 degrees Celsius and about 2500 degrees Celsius. The laser furnace may comprise one or more lasers, with a wavelength tuned to be in the absorption band(s) of the metal oxide input. The laser furnace may exist in a number of configurations. In an embodiment, the laser furnace 104 may be a single collimated beam laser. In another embodiment, the laser furnace 104 may be an array of collimated beam lasers. In another embodiment, the laser 104 may be an array of laser diodes. The power output of the laser furnace may range between around 1 W to 100 MW as the amount of metal oxide being heated, desired heating rate, and target temperature can be changed for different embodiments. The metal oxide 102 may be a number of metal oxides.

There are various embodiments that can expose the metal oxide 102 to laser energy from the laser furnace 104: falling metal oxide particles can enter into the laser energy path, being heated to the target temperature as they fall; a rotary kiln can periodically expose the metal oxide particles to laser energy to reach the target temperature; a stationary or moving bed of particles can be exposed to laser energy to reach the target temperature; or some combination thereof. The target temperature of the metal oxide particles may be range from about 500° C. to about 2500° C.

A system 200 for producing an intermediate metal product is depicted in FIG. 2. A reducing agent 202 is heated to a target temperature by a heating system 204. The target temperature may range from about 500° C. to about 1500° C. The heated reducing agent is brought into contact with the heated metal oxide 102, within the laser furnace 104, at the target temperature to create an intermediate metal product 206, shown in FIG. 2. The intermediate metal product will have a higher percentage of metal than the metal oxide 102, having between about 50 and about 99% metallization (i.e. being between about 50% and about 99% metal), with the balance comprising metal oxide and impurities native to the metal oxide 102. The metal percentage may be measured with x-ray diffraction and Rietveld refinement, x-ray photoelectron spectroscopy, energy dispersive spectroscopy, mass spectroscopy, electrical conductivity, or other techniques that can determine the relative amounts of intermediate metal product 206, metal oxide 102, and other impurities.

In an embodiment, the intermediate metal product 206 can be combined with flux 302 in vessel 304; the desired temperature may be reached with heating system 204, as seen in FIG. 3. Impurities 308 that are not the desired metal, may be removed through reaction with the flux 302 to produce a metal 306 with higher percentage of metal than intermediate metal product 206, as seen in FIG. 3. Impurities 308 may be any element or compound that is not the desired metal. In an embodiment, impurities 308 may be carbon. In another embodiment, impurities 308 may be sulfur. In another embodiment, impurities 308 may be phosphorus. In another embodiment, impurities 308 may be silicon. In another embodiment, impurities 308 may be oxygen. In another embodiment, the impurities 308 may be manganese. In another embodiment, impurities 308 may be a combination of carbon, sulfur, phosphorus, silicon, and oxygen, and manganese.

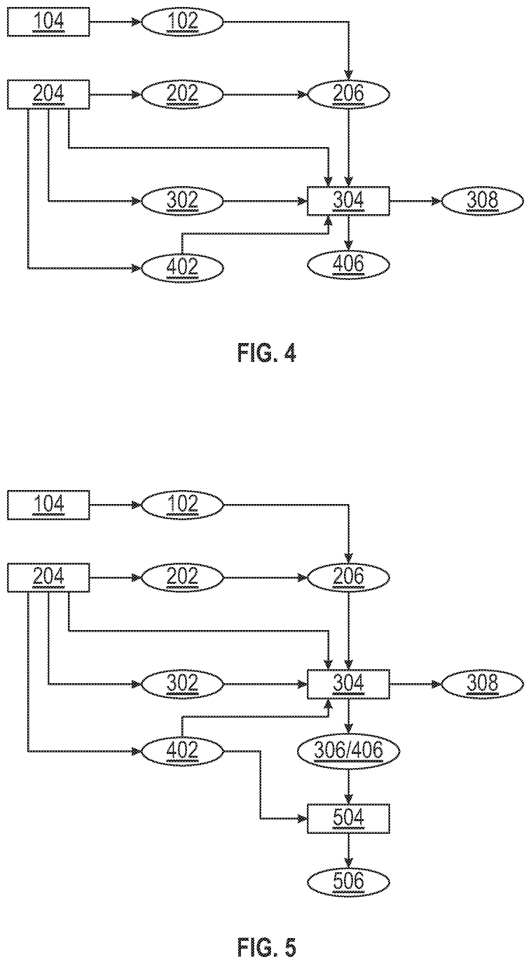

In an embodiment, at least one alloying element 402, which can be heated by the heating system 204, can be added to vessel 304 to produce a metal alloy 406, as seen in FIG. 4.

In another embodiment, the metal oxide 102, after it is heated to the target temperature by the laser furnace 104, may enter metal processing equipment 804 to be converted into an intermediate metal product, metal 306, or metal alloy 406 as seen in FIG. 8. Metal processing equipment 804 may be a number of different embodiments. In an embodiment, metal processing equipment 804 may be an electric arc furnace. In another embodiment, metal processing equipment 804 may be a blast furnace. In another embodiment, metal processing equipment 804 may be a shaft furnace. In another embodiment, metal processing equipment 804 may be a fluidized bed reactor. In another embodiment, metal processing equipment 804 may be a rotary kiln. In another embodiment, metal processing equipment 804 may be a basic oxygen furnace. In another embodiment, metal processing equipment 804 may be a molten oxide electrolysis chamber.

In an embodiment, once the metal 306 or metal alloy 406 is produced, it may be fed to an atomizer 404 to produce a metal powder 506, as shown in FIG. 5. As seen in FIG. 5, at least one alloying element 402 may be added to the metal 306 or metal alloy 406 once it enters the atomizer 504. The metal powder size may range between 10 μm and 300 μm, and may be measured with sieving, optical microscopy techniques, or electron microscopy techniques.

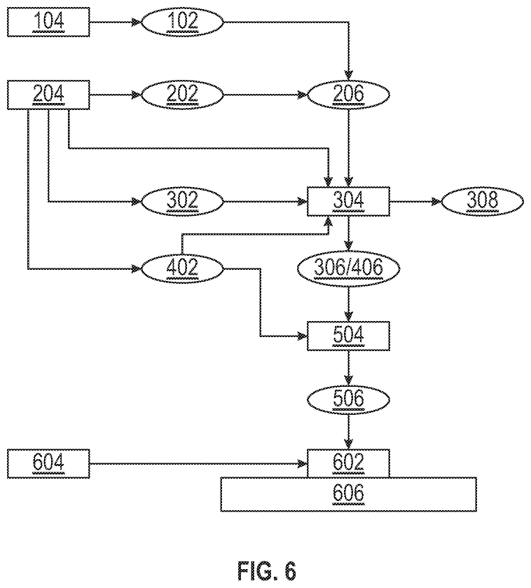

In an embodiment, metal powder 506 can be deposited on the base material 602 as a laser heater 604 moves along the base material 602, as seen in FIG. 6. The metal 506 and the laser heater 604 arrive at the specific area concurrently, with subsequent deposition of the metal 506 as the laser heater 604 moves to an adjacent area. The base material 602 may be set on a temperature-controlled stage 606, with the stage 606 able to move linearly and rotationally to allow the metal 506 to be deposited onto different areas of the base material 602. The at least one laser heater 604 may exist in a number of configurations. In an embodiment, the at least one laser heater 604 may be a single collimated beam laser. In another embodiment, the laser heater 604 may be an array of collimated beam lasers. In another embodiment, the laser heater 604 may be an array of laser diodes.

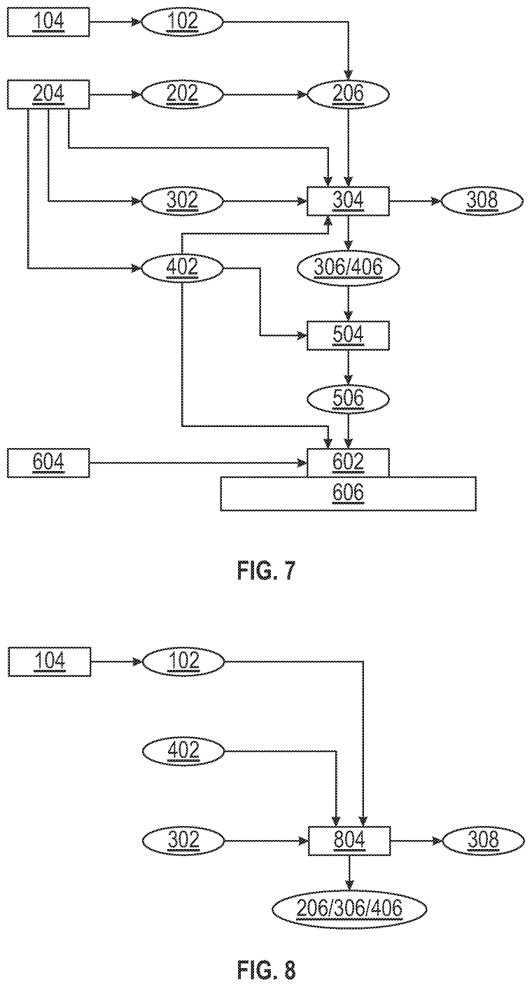

In an embodiment, at least one alloying element 402 may be added to the metal 506 to produce a metal alloy, as seen in FIG. 7. The metal alloy may be deposited onto a base material 602, which is positioned on a temperature-controlled stage 606.

In a falling particle design, the metal oxide 102 flows through a drop tube configuration of the laser furnace 104 with the reducing agent 202 to form an intermediate metal product 206. The reducing agent 202 is pre-heated to a reaction temperature by the heating system 204. The reducing agent may be heated to a temperature range of 500° C. and about 1500° C. The pre-heated reducing agent 202 and the metal oxide 102 is flowed into the laser furnace 104. The laser furnace 104 heats the metal oxide 102 to a reaction temperature in the range of about 500° C. to about 2500° C. In various embodiments, the temperature range may be between about 700° C. and about 2000° C. In other embodiments, the temperature range may be between about 900° C. and about 1500° C. In an embodiment, the time to heat the metal oxide to the reaction temperature may be from about 0.0001 seconds to 1 minute. In various embodiments, the metal oxide heating time may be from about 0.0005 seconds to about 30 seconds. In other embodiments, the metal oxide heating time may be from about 0.00075 seconds to about 15 seconds. In even other embodiments, the metal oxide heating time may be from about 1 second to about 3 seconds. The combination of metal oxide 102 and reducing agent 202 form the intermediate metal product 206 within a reaction time that may range from about 0.00001 seconds to about 1 minute. The reaction time may range from about 0.01 seconds to about 45 seconds. The reaction time may range from about 0.1 seconds to about 30 seconds.

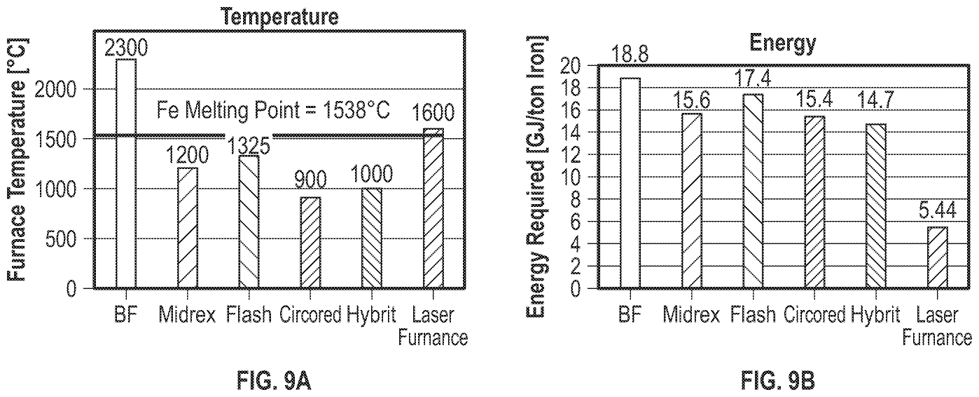

FIGS. 9A-B show the present invention, denoted as Laser Furnace, in comparison with other technologies used to reduce metal oxides to metals. FIG. 9A, with the exception of the blast furnace, the temperatures used in the other technologies fall beneath the melting point of iron, meaning that further processing (and more energy expenditure) would be necessary to create molten iron. FIG. 9B shows that the present invention requires less energy to produce metal than the other technologies. In fact, the blast furnace, denoted as BF, requires almost 3.5 times more energy than the present invention to produce the same amount of metal.

The absorption spectrum of a metal oxide can be used to determine the optimized laser wavelength to be used for heating. Blackbody heaters emit a broad range of wavelengths that metal oxides do not absorb effectively, leading to inefficient and slow heating at industrial scales of metal oxide processing. However, in an embodiment that uses tuned laser light within the metal oxide's absorption band, the target metal oxide temperature can be quickly and efficiently reached. Combining beams from more than one laser enables high power densities and rapid, efficient heating of metal oxides. Lasers that fall within about 180 nm and about 10,600 nm lead to efficient heating of metal oxides.

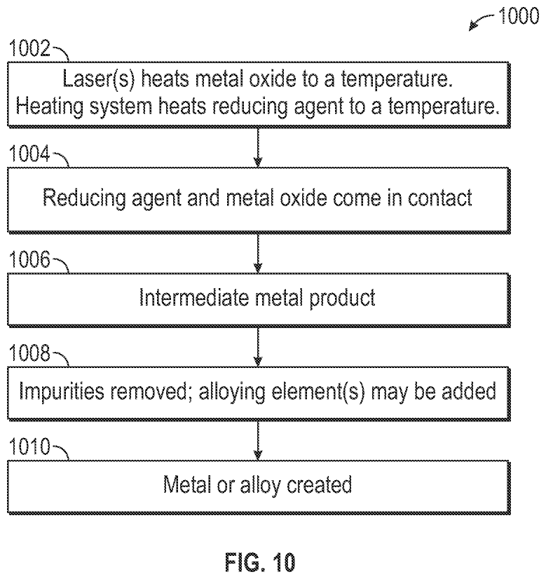

FIG. 10 depicts a method 1000 for reducing a metal oxide. A step is at least one laser interacting with the metal oxide to reach a temperature and heating the reducing agent to a temperature 1002, with the metal oxide heating temperature ranging from about 500° C. to about 2500° C. The heating system interacts with the reducing agent at a temperature ranging from about 500° C. to 1500° C. Another step is the reducing agent with the metal oxide coming in contact 1004. Another step is the production of intermediate metal product 1006 from the reduction of the metal oxide. An optional step is removing impurities from the intermediate metal product and/or adding alloying elements 1008 to create a more pure metal or metal alloy 1010.

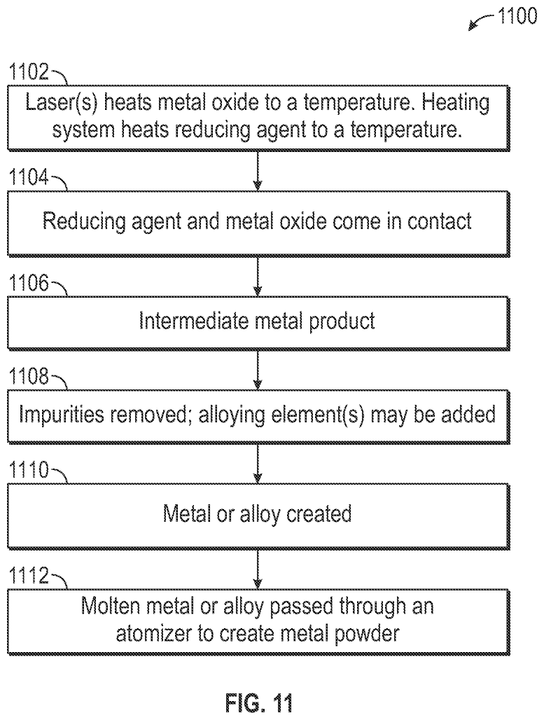

FIG. 11 depicts a method 1100 for reducing a metal oxide. A step is at least one laser interacting with the metal oxide at a temperature and heating the reducing agent to a temperature 1102, with the metal oxide temperature ranging from about 500° C. to about 2500° C. The heating system interacts with the reducing agent at a temperature ranging from 500° C. to about 1500° C. Another step is the reducing agent and the metal oxide coming in contact 1104. Another step is the production of intermediate metal product 1106 from the reduction of the metal oxide. Another step 1108 is removing impurities from the intermediate metal product and/or adding alloying elements, to create a more pure metal or metal alloy 1110. An optional step 1112 is passing the molten metal or alloy through an atomizer to create metal powder. In some embodiments, the metal powder may have rounded or spherical shape. In some embodiments the metal powder may have sizes ranging from 10 to 300 micrometers in diameter. In some embodiments, the metal powder may have sizes ranging from 20 to 75 micrometers in diameter. In some embodiments, the metal powder may have sizes ranging from 45 to 150 micrometers in diameter.

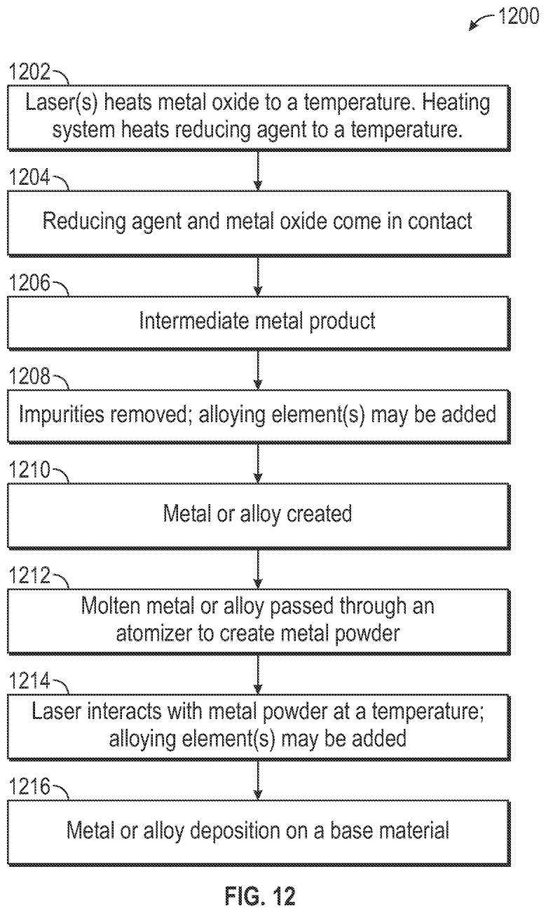

FIG. 12 depicts a method 1200 for reducing a metal oxide to a metal. A step is at least one laser interacting with the metal oxide at a temperature and heating the reducing agent to a temperature 1202, with the metal oxide reaching a temperature ranging from about 500° C. to about 2500° C. The heating system interacts with the reducing agent at a temperature ranging from 500° C. to about 1500° C. Another step is the reducing agent with the metal oxide coming in contact 1204. Another step is the production of intermediate metal product 1206 from the reduction of the metal oxide. Another step is removing impurities from the intermediate metal product and/or adding one or more alloying elements 1208, to create a metal or metal alloy 1210. Another step is passing the molten metal or alloy through an atomizer to create metal powder 1212. The metal powder may have rounded or spherical shape and may have sizes ranging from 10 to 300 micrometers in diameter. Another step is at least one laser interacting with the metal at a temperature 1214. This temperature range is at or above the melting temperature of the metal, up to its boiling point. An optional step is deposition of the metal on a base material 1216, with the metal and laser interacting concurrently at an area and subsequent areas being deposited with metal.

These and other features, aspects and advantages of the present teachings will become better understood with reference to the following description, examples and appended claims.

### Examples

Iron Oxide Reduction to Iron/Steel

Reducing agents of hydrogen, carbon, or carbon monoxide are heated to temperatures ranging from about 500° C. to about 1500° C. in an electric furnace or a plasma heater. Iron oxide may take various forms, including iron(II) oxide, wüstite (FeO), magnetite (Fe3O4), iron(III) oxide (Fe2O3), alpha phase, hematite (α—Fe2O3), beta phase, (β—Fe2O3), gamma phase, maghemite (γ—Fe2O3), and epsilon phase, (ε—Fe2O3). Iron oxide is heated to temperatures ranging from about 900° C. to about 2500° C. within the laser furnace. To arrive at the these temperatures, the laser interacts with the iron oxide for a time ranging from 0.0001 seconds to about 1 minute. The laser that interacts with the iron oxide has a wavelength that ranges from about 180 nm to about 600 nm, depending on the type of laser used. The power of the laser ranges from about 1 watt to about 1 gigawatt, with differing powers based on scale. For instance, lab scale is about 1 kilowatt. Mass scale laser power ranges from about 100 kilowatts to about 1 gigawatt. A pilot plant that produces about 3,000,000 kg/year steel uses laser power of about 12.4 megawatts. To produce as much steel as a typical blast furnace, which produces about 12,000,000 kg/day, the laser power is approximately 810 megawatts. Input rates of iron oxide, on a mass scale, may range from about 0.015 kg/second to about 209 kg/second, with pilot plants averaging about 0.15 kg/second. The reaction time of the reducing agent and the iron oxide ranges from 0.01 seconds to about 10 hours. Iron or steel production rate from iron oxide reduction ranges from about 0.01 kg/second to about 139 kg/second, with a pilot plant producing approximately 0.1 kg/second, with yearly production ranging from about 1 million kg/year to about 4.4 billion kg/year, with a pilot plant producing approximately 3 million kg/year. In the event that an intermediate metal product is produced (before the production of iron or steel), the intermediate metal product as a metallization ranging from about 50% to about 99%. Passing the resultant iron through an atomizer produces powder, with the powder having particle sizes ranging from about 10 microns to about 300 mm. The reactant iron oxide has particle sizes ranging from about 1 micron to about 20 mm. Following iron production, alloying elements may be added to iron to produce steel. Several steels are possible, including but not limited to Stainless steel such as 316 or 316L, austenitic steel such as 304 or 304L, ferritic steel such as 430 or 434, martensitic steel such as 440, High carbon steel such as 1080, Low carbon/mild steel such as A36, Medium carbon/high-tensile steel such as 4140, 4340, and Alloy steel such as 6150, 8620.

Measuring Carbon Dioxide from the Metal Oxide Reduction

Carbon dioxide emissions can be measured using gas chromatography or an infrared gas analyzer. In the vicinity of the laser furnace, the site of the reaction between the reducing gas and the metal oxide, an infrared gas analyzer analyzes the off-gas stream that results from metal oxide reduction. Using such an analyzer allows dynamic measurement of carbon dioxide levels. The analyzer evaluates proportional differences between a sample, in this case the off-gas stream, and a reference. Non-dispersive infrared sensors emit infrared radiation at particular wavelengths, with the wavelengths passing through a sample tube and a reference tube; the reference tube contains a non-absorbing gas. Due to the nature of the non-absorbing gas, the wavelengths passing through the reference tube remain unchanged. The wavelengths change as they pass through the sample tube if carbon dioxide is present in the sample tube, since carbon dioxide absorbs the wavelengths. Carbon dioxide concentration is typically provided as parts-per-million or as a percentage. Based on the reducing agent used to react with the metal oxide, the carbon dioxide generated differs.

### Other Embodiments

The detailed description set-forth above is provided to aid those skilled in the art in practicing the present invention. However, the invention described and claimed herein is not to be limited in scope by the specific embodiments herein disclosed because these embodiments are intended as illustration of several aspects of the invention. Any equivalent embodiments are intended to be within the scope of this invention. Indeed, various modifications of the invention in addition to those shown and described herein will become apparent to those skilled in the art from the foregoing description which do not depart from the spirit or scope of the present inventive discovery. Such modifications are also intended to fall within the scope of the appended claims.

What is claimed:

1. A system for producing an intermediate metal product without generating significant carbon dioxide, the system comprising:
a laser furnace comprising at least one laser, the at least one laser having a wavelength ranging between about 180 nm and about 10,600 nm and power ranging between about 1 Watt and about 1 gigawatt, wherein the at least one laser interacts with the metal oxide to produce the intermediate metal product without generation of significant carbon dioxide and the intermediate metal product has a metallization ranging from about 50% to about 99%; and
a reducing agent and a metal oxide that come into contact within the laser furnace.

2. The system of claim 1, wherein the reducing agent is selected from the group consisting of hydrogen, carbon, and carbon monoxide.

3. The system of claim 1, wherein the reducing agent and the metal oxide are heated separately.

4. The system of claim 1, wherein the at least one laser has a wavelength ranging between about 425 nm and about 475 nm.

5. The system of claim 1, wherein the laser furnace is composed of steel lined with a refractory ceramic coating, the refractory ceramic coating selected from the group consisting of aluminum oxide, zirconium oxide, silicon carbide, graphite, silicon oxide, and combinations thereof, and the laser furnace assumes a shape of one of a quadrangular shaft and a circular shaft.

6. The system of claim 1, wherein impurities are removed from the intermediate metal product

7. The system of claim 6, wherein the intermediate metal product is combined with at least one alloying element.

8. The system of claim 1, further comprising a heating system that heats the reducing agent to a temperature ranging between about 500° C. and about 1500° C.

9. The system of 8, wherein the heating system comprises at least one of induction heaters, resistive heaters, electron beams, microwaves, heat pumps, heat exchangers, plasma heaters, and combinations thereof.

10. The system of claim 1, wherein the metal oxide is heated to a range from about 500° C. to about 2500° C.

11. The system of claim 1, wherein the at least one laser interacts with the metal oxide for a time ranging from about 0.00001 seconds to about 1 minute.

12. A method of producing an intermediate metal product without generating significant carbon dioxide, the method comprising:
providing a system for producing an intermediate metal product without generating significant carbon dioxide, the system comprising:
a laser furnace comprising at least one laser, the at least one laser having a wavelength ranging between about 180 nm and about 10,600 nm and power ranging between about 1 Watt and about 1 gigawatt, wherein the at least one laser interacts with the metal oxide to produce the intermediate metal product without generation of significant carbon dioxide and the intermediate metal product has a metallization ranging from about 50% to about 99%; and
a reducing agent and a metal oxide that come into contact within the laser furnace;
producing an intermediate metal product from combining the reducing agent and the metal oxide within the laser furnace.

13. The method of claim 12, wherein at least one alloying element is added to the intermediate metal product.

14. The method of claim 12, wherein the metal oxide is heated to a reaction temperature ranging between about 500° C. and about 2500° C.

15. The method of claim 12, wherein the system further comprises a heating system that heats the reducing agent to a temperature ranging between about 500° C. and about 1500° C., with the heating system comprising of at least one of induction heaters, resistive heaters, electron beams, microwaves, heat pumps, heat exchangers, plasma heaters, and combinations thereof.

16. The method of claim 12, wherein the at least one laser interacts with the metal oxide for a reaction time ranging between about 0.00001 seconds and about 1 hour.

17. The method of claim 12, wherein impurities are removed from the intermediate metal product.

18. The method of claim 17, wherein at least one alloying element is added to the intermediate metal product.

19. The method of claim 17, wherein the intermediate metal product is fed to an atomizer to create powder particles.

20. The method of claim 12, wherein the metal oxide is fed to at least one of an electric arc furnace, a blast furnace, a shaft furnace, a fluidized bed reactor, a basic oxygen furnace, a molten oxide electrolysis chamber to produce one of an intermediate metal product, a metal, and a metal alloy.
